(19) United States
(12) Patent Application Publication
(10) Pub. No.: US 2013/0326823 A1
(43) Pub. Date: Dec. 12, 2013

(54) LAUNDRY DETERGENTS

(71) Applicant: The Procter & Gamble Company, Cincinnati, OH (US)

(72) Inventors: Nigel Patrick SOMERVILLE ROBERTS, Newcastle upon Tyne (GB); Haiyan SONG, Beijing (CN); Jerome Macaisa CASTRO, Newcastle upon Tyne (GB); Jacqueline L'HOSTIS, Seneffe (BE); Stephanie LECOMTE, Seneffe (BE)

(21) Appl. No.: 13/909,292

(22) Filed: Jun. 4, 2013

(30) Foreign Application Priority Data
Jun. 8, 2012 (WO) CN2012/000784

(51) Int. Cl. C11D 3/00

(52) U.S. Cl. CPC C11D 3/0026
USPC 8/137; 510/276

(57) ABSTRACT

The present invention relates to a laundry detergent comprising a granulated foam control composition and an anionic detersive surfactant, wherein said granulated foam control composition comprises:
(a) a foam control agent comprising:
   i. a polydiorganosiloxane fluid comprising units of the formula

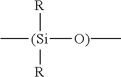

where each group R, which may be the same or different, is selected from an alkyl group having 1 to 36 carbon atoms or an aryl group or aralkyl group having 1 to 36 carbon atoms, the mean number of carbon atoms in the groups R being at least 1.3;
   ii. a hydrophobic filler dispersed in the polydiorganosiloxane fluid;
(b) an organic additive having a melting point of from about 45° C. to about 100° C. comprising a polyol ester which is a polyol esterified by carboxylate groups each having 7 to 36 carbon atoms, and which is miscible with said polydiorganosiloxane fluid;
(c) a water soluble inorganic particulate carrier;
(d) a cationic polymer;
(e) a surfactant.

### FIELD OF THE INVENTION

The present invention relates to laundry detergents containing granulated foam control compositions.

### BACKGROUND OF THE INVENTION

Laundry detergents comprising anionic detersive surfactants for cleaning fabrics such as clothing have been known for many years. Laundry detergents typically create suds during their use including hand-wash use. During hand washing of clothes and fabrics, a large volume of suds is initially desirable as it indicates to the user that sufficient surfactant is present, working and cleaning the fabrics. However, during the rinse cycle, consumers tend to believe that if suds are still present then there is surfactant residue that remains on the clothes, and therefore believe that the clothes are not yet “clean”. They thus tend to rinse more times until the suds are not seen in the rinse.

Hence, while a large volume of suds is desirable during cleaning, it paradoxically is undesirable during rinsing. As water is often a limited resource, especially in hand washing countries, the use of water for rinsing reduces the amount available for other possible uses, such as irrigation, drinking, bathing, etc.

A suds suppressor which is selectively active during rinsing can eliminate unwanted excessive suds during rinsing and thus change the consumer's perception of the sufficiency and efficacy of a single rinse, thereby saving water and effort utilized on repeated rinses.

Suds suppressors are well-known in, for example, automatic dishwashing detergents and laundry detergents for front-loading washing machines. Sample suds suppressors are disclosed in for example, EP1075683A, EP 1070526A, U.S. Pat. No. 7,632,890B and EP 210731A. However, as typical suds suppressors do not distinguish between the wash and rinse conditions, they do not solve the problem of providing suds during washing and yet reducing suds during rinsing. Particularly, in a hand wash situation, the consumers are used to seeing suds during the wash, and if no suds are present, then consumers think that the laundry detergent contains insufficient surfactant to perform up to expectations.

There is a need in the art for a suds control composition which provides a satisfying suds volume during the washing stage and a significantly reduced suds volume after a single rinse process, is desired.

The Inventors surprisingly found that a laundry detergent comprising a granulated foam control composition and an anionic surfactant, wherein said granulated foam control composition comprises a foam control agent comprising a polydiorganosiloxane fluid, hydrophobic filler, and said granulated foam control composition also comprises an organic additive, a water soluble inorganic particulate carrier a cationic polymer and a surfactant exhibited improved suds retention during the wash but improved suds reduction during the rinse as compared to a laundry detergent outside of the present invention. It was also surprisingly found that laundry detergent compositions according to the present invention also exhibited improved ageing stability.

### SUMMARY OF THE INVENTION

The present invention relates to a laundry detergent comprising a granulated foam control composition and an anionic detersive surfactant, wherein said granulated foam control composition comprises:
(a) a foam control agent comprising:
   i. a polydiorganosiloxane fluid comprising units of the formula

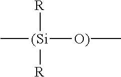

where each group R, which may be the same or different, is selected from an alkyl group having 1 to 36 carbon atoms or an aryl group or aralkyl group having 1 to 36 carbon atoms, the mean number of carbon atoms in the groups R being at least 1.3;
   ii. a hydrophobic filler dispersed in the polydiorganosiloxane fluid;
(b) an organic additive having a melting point of from about 45° C. to about 100° C. comprising a polyol ester which is a polyol esterified by carboxylate groups each having 7 to 36 carbon atoms, and which is miscible with said polydiorganosiloxane fluid;
(c) a water soluble inorganic particulate carrier;
(d) a cationic polymer;
(e) a surfactant.

### DETAILED DESCRIPTION OF THE INVENTION

All temperatures herein are in degrees Celsius (° C.) unless otherwise indicated. All conditions herein are at 20° C., and atmospheric pressure unless otherwise specifically stated. All polymer molecular weights are by average number molecular weight unless otherwise specifically noted.

As used herein, “suds” indicates a non-equilibrium dispersion of gas bubbles in a relatively smaller volume of a liquid. The terms like “suds”, “foam” and “lather” can be used interchangeably in the present specification.

The present invention relates to a laundry detergent comprising a granulated foam control composition and an anionic detersive surfactant, wherein said granulated foam control composition comprises a foam control agent comprising a polydiorganosiloxane fluid, hydrophobic filler, and said granulated foam control composition also comprises an organic additive, a water soluble inorganic particulate carrier, a cationic polymer and a surfactant.

### Laundry Detergent

The laundry detergent powder is suitable for any laundry detergent application, for example: laundry, including automatic washing machine laundering and hand laundering, and even bleach and laundry additives.

The laundry detergent is preferably a powder or granular laundry detergent. It can be a fully formulated detergent product, such as a fully formulated laundry detergent product, or it can be combined with other particles to form a fully formulated detergent product, such as a fully formulated laundry detergent product. The granulated foam control composition may be combined with other particles such as: enzyme particles; perfume particles including agglomerates or extrudates of perfume microcapsules, and perfume encapsulates such as starch encapsulated perfume accord particles; surfactant particles, such as non-ionic detersive surfactant particles including agglomerates or extrudates, anionic detersive surfactant particles including agglomerates and extrudates, and cationic detersive surfactant particles including agglomerates and extrudates; polymer particles including soil release polymer particles, cellulosic polymer particles; buffer particles including carbonate salt and/or silicate salt particles, preferably a particle comprising carbonate salt and silicate salt such as a sodium carbonate and sodium silicate co-particle, and particles and sodium bicarbonate; other spray-dried particles; fluorescent whitening particles; aesthetic particles such as coloured noodles or needles or lamellae particles; bleaching particles such as percarbonate particles, especially coated percarbonate particles, including carbonate and/or sulphate coated percarbonate, silicate coated percarbonate, borosilicate coated percarbonate, sodium perborate coated percarbonate; bleach catalyst particles, such as transition metal catalyst bleach particles, and imine bleach boosting particles; performed peracid particles; hueing dye particles; and any mixture thereof.

It may also be especially preferred for the laundry detergent powder to comprise low levels, or even be essentially free, of builder. By essentially free of it is typically meant herein to mean: “comprises no deliberately added”. In a preferred embodiment, the laundry detergent comprises no builder.

### Anionic Detersive Surfactant

The anionic detersive surfactant can be alkyl benzene sulphonic acid or salt thereof, alkyl ethoxylated sulphate, or a mixture thereof. Preferably, the anionic detersive surfactant is a mixture of alkyl benzene sulphonic acid or salt thereof and alkyl ethoxylated sulphate.

Suitable anionic detersive surfactants include sulphate and sulphonate detersive surfactants.

Preferred sulphonate detersive surfactants include alkyl benzene sulphonate, preferably C₁₀₋₁₃ alkyl benzene sulphonate. Suitable alkyl benzene sulphonate (LAS) is obtainable, preferably obtained, by sulphonating commercially available linear alkyl benzene (LAB); suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic detersive surfactant is alkyl benzene sulphonate that is obtained by DETAL catalyzed process, although other synthesis routes, such as HF, may also be suitable.

Preferred sulphate detersive surfactants include alkyl sulphate, preferably C₈₋₁₈ alkyl sulphate, or predominantly C₁₂ alkyl sulphate.

Another preferred sulphate detersive surfactant is alkyl alkoxylated sulphate, preferably alkyl ethoxylated sulphate, preferably a C₈₋₁₈ alkyl alkoxylated sulphate, preferably a C₈₋₁₈ alkyl ethoxylated sulphate, preferably the alkyl alkoxylated sulphate has an average degree of alkoxylation of from 0.5 to 20, preferably from 0.5 to 10, preferably the alkyl alkoxylated sulphate is a C₈₋₁₈ alkyl ethoxylated sulphate having an average degree of ethoxylation of from 0.5 to 10, preferably from 0.5 to 7, more preferably from 0.5 to 5 and most preferably from 0.5 to 3.

The alkyl sulphate, alkyl alkoxylated sulphate and alkyl benzene sulphonates may be linear or branched, substituted or un-substituted.

The anionic detersive surfactant typically has a sudsing profile of at least about 5 cm, or from about 8 cm to 25 cm, as measured by the below Suds Testing Protocol herein. The level of anionic surfactant is from about 0.5%, 1%, 2%, 5% or 8% to about 20%, 30%, 40%, 50%, by weight of the laundry detergent.

In one embodiment, the anionic detersive surfactant comprises an anionic moiety, or multiple anionic moieties. Without being bound by theory, it is believed that an anionic moiety allows the anionic detersive surfactant to bind with the cationic polymer and form a coacervate in the wash liquor during the wash. The coacervate is believed to be able to adhere and deposit onto a fabric during washing, then selectively break down when the concentration of anionic detersive surfactant drops during the rinsing stage as compared to the concentration in a laundry liquor during washing, thereby releasing the antifoaming composition.

In an embodiment, the present laundry detergent can comprise a mixture of anionic surfactants. The anionic surfactant may be a water-soluble salt, or an alkali metal salt, or a sodium and/or potassium salt.

Suds boosting co-surfactants may also be used to boost suds during washing. Many such suds boosting co-surfactants are often also anionic surfactants, and are included in the total anionic surfactant above.

### Granulated Foam Control Composition

The granulated foam control compositions are typically added to the laundry detergents at a level of from about 0.1%, 0.2%, 0.5% to about 1.0%, 10% by weight. The granulated foam control compositions of the invention were found to have a minimum impact on the foam during the wash.

The granulated foam control composition may comprise a foam control particle comprising a core comprising the foam control agent, the organic additive and the water soluble inorganic particulate carrier, and the core being at least partially coated with a coating comprising the cationic polymer and the surfactant.

Alternatively, the granulated foam control composition may comprise a plurality of water soluble inorganic carrier particles (C) coated and bonded together by a liquid composition comprising the foam control agent (A), the organic additive (B), the cationic polymer (D) and the surfactant (E).

In one embodiment, the surfactant is an anionic surfactant which is added to the other components to make the granulated foam control composition as a pre-formed coacervate of anionic surfactant and cationic polymer is made. The pre-formed coacervate may also comprise non-ionic surfactant.

The ratio of the cationic polymer to the surfactant in the granulated foam control composition may be between 1:9 and 9:1.

a) Foam Control Agent

The foam control agent comprises (i) a polydiorganosiloxane fluid, (ii) a hydrophobic filler and optionally an organosilicone resin. The polydiorganosiloxane fluid can be a polydiorganosiloxane fluid comprising units of the formula:

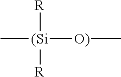

where each group R, which may be the same or different, is selected from an alkyl group having 1 to 36 carbon atoms or an aryl group or aralkyl group having 1 to 36 carbon atoms, the mean number of carbon atoms in the groups R being at least 1.3. In one embodiment, the polydiorganosiloxane fluid preferably has no more than 5 mole % branching units such as RSiO_{3/2} units or crosslink sites, most preferably less than 2 mole % branching units. The mean number of carbon atoms in the groups R is preferably at least 1.3, and is more preferably at least 2.0, most preferably at least 2.5, if the groups R do not include aryl or aralkyl groups. The polydiorganosiloxane fluid is free from non-silicone polymer chains such as polyether chains.

One preferred example of a polydiorganosiloxane fluid is a polysiloxane comprising at least 10% diorganosiloxane units of the formula

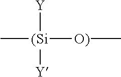

and up to 90% diorganosiloxane units of the formula

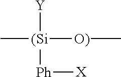

wherein X denotes a divalent aliphatic organic group bonded to silicon through a carbon atom; Ph denotes an aromatic group; Y denotes an alkyl group having 1 to 4 carbon atoms; and Y′ denotes an aliphatic hydrocarbon group having 1 to 24 carbon atoms, as described in EP1075864. The diorganosiloxane units containing a —X-Ph group preferably comprise 5 to 60% of the diorganosiloxane units in the fluid. The group X is preferably a divalent alkylene group having from 2 or 4 to 10 carbon atoms, but can alternatively contain an ether linkage between two alkylene groups or between an alkylene group and -Ph, or can contain an ester linkage.

In one embodiment, Ph is a phenyl group, but may be substituted for example by one or more methyl, methoxy, hydroxy or chloro group, or two substituents on the Ph group may together form a divalent alkylene group, or may together form an aromatic ring, resulting in conjunction with the Ph group in e.g. a naphthalene group. In another embodiment, X-Ph group is 2-phenylpropyl —CH₂—CH(CH₃)—C₆H₅. The group Y can be methyl but can be ethyl, propyl or butyl as well. The group Y′ has from 1 or 2 to 16 or 18 carbon atoms, for example it is ethyl, methyl, propyl, isobutyl or hexyl. Mixtures of alkyl groups Y′ can be used, for example ethyl and methyl, or a mixture of dodecyl and tetradecyl. Other groups may be present, for example haloalkyl groups such as chloropropyl, acyloxyalkyl or alkoxyalkyl groups or aromatic groups such as phenyl bonded directly to Si.

The polysiloxane fluid containing —X-Ph groups may be a substantially linear siloxane polymer or may have some branching, for example branching in the siloxane chain by the presence of some tri-functional siloxane units, or branching by a multivalent, e.g. divalent or trivalent, organic or silicon-organic moiety linking polymer chains, as described in EP 1075684A.

An alternative example of a preferred polydiorganosiloxane fluid is a polysiloxane comprising 50-100% diorganosiloxane units of the formula

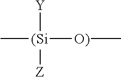

and optionally up to 50% diorganosiloxane units of the formula

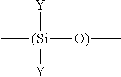

wherein Y denotes an alkyl group having 1 to 4 carbon atoms and Z denotes an alkyl group having 6 to 18 carbon atoms. The groups Y in such a polydiorganosiloxane are preferably methyl or ethyl. The alkyl group Z may preferably have from 6 to 12 or 14 carbon atoms, for example octyl, hexyl, heptyl, decyl, or dodecyl, or a mixture of dodecyl and tetradecyl.

In one embodiment, the number of siloxane units (DP, degree of polymerization) in the average molecule of the polysiloxane fluid of either of the above types is at least 5, more preferably from about 5, 10 and 20 to about 200, 1000 and 5000. The end groups of the polysiloxane can be any of those conventionally present in siloxanes, for example trimethylsilyl end groups.

The polydiorganosiloxane fluid containing —X-Ph groups, or the polydiorganosiloxane fluid containing —Z groups, is preferably present as at least 80%, 95% by weight of the polysiloxane fluid content of the foam control composition, more preferably as 100% of the polysiloxane fluid.

The polydiorganosiloxane fluid can alternatively be a polydiorganosiloxane in which the organic groups are substantially all alkyl groups having 2 to 4 carbon atoms, for example polydiethylsiloxane.

The foam control agent contains a hydrophobic filler dispersed in the polydiorganosiloxane fluid. Hydrophobic fillers for foam control agents are well known and are particulate materials which are solid at 100° C., such as silica, preferably with a surface area as measured by BET measurement of at least 50 m²/g, titania, ground quartz, alumina, an aluminosilicate, zinc oxide, magnesium oxide, a salt of an aliphatic carboxylic acids, a reaction product of an isocyanate with an amine, e.g. cyclohexylamine, or an alkyl amide such as ethylenebisstearamide or methylenebisstearamide. Mixtures of two or more of these can be used.

Some of the fillers mentioned above are not hydrophobic in nature, but can be used if made hydrophobic. This can be done either in situ (i.e. when dispersed in the polysiloxane fluid), or by pre-treatment of the filler prior to mixing with the polysiloxane fluid. A preferred filler is silica which is made hydrophobic. Preferred silica materials are those which are prepared by heating, e.g. fumed silica, or precipitation. The silica filler may for example have an average particle size of 0.5, 2 and 5 to about 25, 30 and 50 μm. It can be made hydrophobic by treatment with a fatty acid, but is preferably made hydrophobic by the use of methyl substituted organosilicon materials such as dimethylsiloxane polymers which are end-blocked with silanol or silicon-bonded alkoxy groups, hexamethyldisilazane, examethyldisiloxane or organosilicone resins containing (CH₃)₃SiO_{1/2} groups and silanol groups. Hydrophobing is generally carried out at a temperature of at least 100° C. Mixtures of fillers can be used, for example a highly hydrophobic silica filler which is commercially available under the name Sipemat D10 from Evonik together with a partially hydrophobic silica such under the name Aerosil R972 from Evonik.

The amount of hydrophobic filler in the foam control agent of the invention is preferably 0.5-50% by weight based on the foam control agent, more preferably from 1 up to 10 or 15% and most preferably 2 to 8% by weight.

The foam control agent optionally contains an organosilicone resin which is associated with the polydiorganosiloxane fluid. Such an organosilicone resin can enhance the foam control efficiency of the polysiloxane fluid. This is particularly true for polysiloxane fluids containing —X-Ph groups, as described in EP 1075684A, and is also true for polysiloxane fluids containing —Z groups. In such polysiloxane fluids, the resin modifies the surface properties of the fluid.

The organosilicone resin is generally a non-linear siloxane resin and preferably consists of siloxane units of the formula R′aSiO_{4-a/2} wherein R′ denotes a hydroxyl, hydrocarbon or hydrocarbonoxy group, and wherein ‘a’ has an average value of from 0.5 to 2.4. It preferably consists of monovalent trihydrocarbonsiloxy (M) groups of the formula R″₃SiO_{1/2} and tetrafunctional (Q) groups SiO_{4/2} wherein R″ denotes a monovalent hydrocarbon group. The number ratio of M groups to Q groups is preferably in the range 0.4:1 to 2.5:1 (equivalent to a value of a in the formula R′ₐSiO_{4-a/2} of 0.86 to 2.15), more preferably 0.4:1 to 1.1:1 and most preferably 0.5:1 to 0.8:1 (equivalent to a=1.0 to a=1.33).

The organosilicone resin is preferably a solid at room temperature. The molecular weight of the resin can be increased by condensation, for example by heating in the presence of a base. The base can for example be an aqueous or alcoholic solution of potassium hydroxide or sodium hydroxide, e.g. a solution in methanol or propanol. A resin comprising M groups, trivalent R″SiO_{3/2} (T) units and Q units can alternatively be used, or up to 20% of units in the organosilicone resin can be divalent units R″₂SiO_{2/2}. The group R″ is preferably an alkyl group having 1 to 6 carbon atoms, for example methyl or ethyl, or can be phenyl. It is particularly preferred that at least 80%, most preferably substantially all, R″ groups present are methyl groups. The resin may be a trimethyl-capped resin.

The organosilicone resin is preferably present in the foam control agent at 1-50% by weight based on the polysiloxane fluid, particularly 2-30% and most preferably 4-15%. The organosilicone resin may be soluble or insoluble in the polysiloxane fluid. If the resin is insoluble in the polysiloxane fluid, the average particle size of the resin may for example be from about 0.5 and 2 to about 50 and 400 μm.

The granulated foam control composition of the invention can contain additional ingredients such as a density adjuster, a color preservative such as a maleate or fumarate, e.g. bis(2-methoxy-1-ethyl)maleate or diallyl maleate, an acetylenic alcohol, e.g. methyl butynol, or cyclooctadiene, a thickening agent such as carboxymethyl cellulose, polyvinyl alcohol or a hydrophilic or partially hydrophobed fumed silica, or a coloring agent such as a pigment or dye.

b) Organic Additive

The organic additive having a melting point of from about 45° C. to about 100° C. is miscible with the polydiorganosiloxane fluid. By ‘miscible’, it means that materials in the liquid phase (i.e., molten if necessary) mixed in the proportions in which they are present in the foam control composition do not show phase separation. This can be judged by the clarity of the liquid mixture in the absence of any filler or resin. If the liquids are miscible, the mixture is clear and remains as one phase. If the liquids are immiscible, the mixture is opaque and separates into two phases upon standing. The organic additive increases the foam control efficiency. We have found that additives of melting point at least about 45° C. are effective in increasing foam control efficiency in the rinse.

The organic additive comprises a polyol ester, which is a polyol, partially or fully esterified by carboxylate groups each having 7 to 36 carbon atoms. The polyol ester is preferably a glycerol ester or an ester of a higher polyol such as pentaerythritol or sorbitol. The polyol ester is preferably a monocarboxylate or polycarboxylate (for example a dicarboxylate, tricarboxylate or tetracarboxylate) in which the carboxylate groups each having 18 to 22 carbon atoms. Such polyol carboxylates tend to have a melting point of at least 45° C. The polyol ester can be a diester of a glycol such as ethylene glycol or propylene glycol, preferably with a carboxylic acid having at least from 14, 18 to 22 carbon atoms, for example ethylene glycol distearate. Examples of glycerol esters include glycerol tristearate and glycerol esters of saturated carboxylic acids having 20 or 22 carbon atoms such as the material of melting point about 54° C. commercially available under the trade name Synchrowax HRC from Croda, believed to be mainly a triglyceride of C₂₂ fatty acid with some C₂₀ and C₁₈ chains. Alternative suitable polyol esters are esters of pentaerythritol such as pentaerythritol tetrabehenate and pentaerythritol tetrastearate.

The polyol ester can contain fatty acids of different chain length, which is common in natural products. The organic additive can be a mixture of polyol esters, for example a mixture of esters containing different carboxylate groups such as glycerol tripalmitate and glycerol tristearate, or glycerol tristearate and Synchrowax HRC, or ethylene glycol distearate and Synchrowax HRC.

The organic additive can also comprise a more polar polyol ester. In one embodiment, the polar polyol esters include partially esterified polyols including monoesters or diesters of glycerol with a carboxylic acid having 8 to 30 carbon atoms, for example glycerol monostearate, glycerol monolaurate, glycerol distearate or glycerol monobehanate. Mixtures of monoesters and diesters of glycerol can be used. Partial esters of other polyols are also useful, for example propylene glycol monopalmitate, sorbitan monostearate or ethylene glycol monostearate.

c) Water-Soluble Inorganic Particulate Carrier

Examples of water-soluble inorganic particulate carriers are phosphates, for example powdered or granular sodium tripolyphosphate; sulphates, for example sodium sulphate; carbonates, for example sodium carbonate, anhydrous sodium carbonate or sodium carbonate monohydrate; silicates, for example sodium silicate; citrates, for example sodium citrate; acetates, for example sodium acetate; sodium sesquicarbonate; sodium bicarbonate; and mixtures thereof. The particle size of the water-soluble inorganic carrier is preferably in the range of about 1 to about 30 μm, more preferably about 1 to about 20 μm. In one aspect, the granulated foam control composition may be covered by water-soluble inorganic particulate carriers, forming a granulated foam control composition which can readily be incorporated in a detergent powder.

In one embodiment, the granulated foam control composition comprises a water-insoluble inorganic ingredient, preferably the water-insoluble inorganic ingredient being zeolite or silica, most preferably zeolite. In one aspect the water-insoluble inorganic ingredient is blended with the water-soluble inorganic carrier. The water-insoluble inorganic ingredient comprises no more than 50 wt %, or 20 wt %, or 10 wt %, or 5 wt % of the granulated foam control composition.

d) Cationic Polymer

The cationic polymer is a polymer having a net cationic charge. The cationic polymer can be an amphoteric polymer. The amphoteric polymers of the present invention will also have a net cationic charge, i.e. the total cationic charges on these polymers will exceed the total anionic charge. The charge density of the charged polymer ranges from about 0.05, 0.5 and 2.5 to about 7, 12 and 23 milliequivalents/g (hereinafter, briefly, “meq/g”). The charge density is calculated by dividing the number of net charge per repeating unit by the molecular weight of the repeating unit. The positive charges could be on the backbone of the polymers or the side chains of polymers. For polymers with amine monomers, the charge density depends on the pH of the carrier. For these polymers, charge density is measured at a pH of 7.

The weight-average molecular weight of the cationic polymer will generally be from about 80,000, about 150,000, about 200,000 to about 3,000,000, about 4,000,000, as determined by size exclusion chromatography relative to polyethyleneoxide standards with R¹ detection. The mobile phase used in the chromatography is a solution of 20% methanol in 0.4M MEA, 0.1 M NaNO₃, 3% acetic acid on a Waters Linear Ultrandyrogel column, 2 in series. Columns and detectors are kept at 40° C. Flow rate is set to 0.5 mL/min.

The molecular weight and charge density of the cationic polymer can act to “compensate” for each other. Lower charge density polymers will work provided their molecular weight is sufficiently high, and lower molecular weight polymers will work provided their charge density is sufficiently high. So, there appears to be an optimum cationicity parameter, where the cationicity parameter is defined as the product of molecular weight * charge density/1000 (MW*CD/1000). Preferred charged polymers have a cationicity parameter of from about 50, about 100, about 150 to about 50,000, about 70,000, about 90,000 meq*Da/g.

Nonlimiting examples of the cationic polymer can include;

a. Cationic Polysacacacahrides:

Cationic polysaccharides include but not limited to cationic cellulose derivatives, cationic guar gum derivatives, chitosan and derivatives and cationic starches. Cationic polysacchrides have a molecular weight from about 50,000 to about 2 million, preferably from about 100,000 to about 1,500,000.

One group of preferred cationic polysaccharides is shown in Structural Formula I as follows:

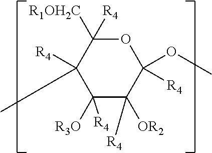

Wherein R¹, R², R³ are each independently H, C1-24 alkyl (linear or branched),

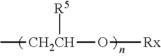

wherein n is from about 0 to about 10; R^{x} is H, C1-24 alkyl (linear or branched) or

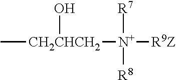

or mixtures thereof, wherein Z is a water soluble anion, preferably chloride, bromide iodide, hydroxide, phosphate sulfate, methyl sulfate and acetate; R⁵ is selected from H, or C1-C6 alkyl or mixtures thereof; R⁷, R⁸ and R⁹ are selected from H, or C1-C28 alkyl, benzyl or substituted benzyl or mixtures thereof.

R⁴ is H or —(P)ₘ—H, or mixtures thereof; wherein P is a repeat unit of an addition polymer formed by a cationic monomer. In one embodiment, the cationic monomer is selected from methacrylamidotrimethylammonium chloride, dimethyl diallyl ammonium having the formula:

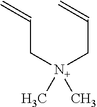

which results in a polymer or co-polymer having units with the formula:

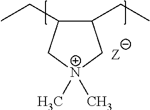

wherein Z′ is a water-soluble anion, preferably chloride, bromide iodide, hydroxide, phosphate sulfate, methyl sulfate and acetate or mixtures thereof and m is from about 1 to about 100.

Alkyl substitution on the saccharide rings of the polymer ranges from about 0.01% to 5% per sugar unit, more preferably from about 0.05% to 2% per glucose unit, of the polymeric material.

Preferred cationic polysaccahides include cationic hydroxyalkyl celluloses. Examples of cationic hydroxyalkyl cellulose include those with the INCI name Polyquaternium10 such as those sold under the trade names Ucare Polymer JR 30M, JR 400, JR 125, LR 400 and LK 400 polymers; Polyquaternium 67 sold under the trade name Softcat SK TM, all of which are available from Amerchol Corporation Edgewater NJ; and Polyquaternium 4 available under the trade name Celquat H200 and Celquat L-200 from National Starch and Chemical Company, Bridgewater, N.J. Other preferred polysaccharides include hydroxyethyl cellulose or hydroxypropylcellulose quaternized with glycidyl C12-C22 alkyl dimethyl ammonium chloride. Examples of such polysaccahrides include the polymers with the INCI names Polyquaternium 24 sold under the trade name Quaternium LM 200, PG-hydroxyethylcellulose lauryldimonium chloride sold under the trade name Crodacel LM, PG-hydroxyethylcellulose cocodimonium chloride sold under the trade name Crodacel QM and, PG-hydroxyethylcellulose stearyldimonium chloride sold under the trade name Crodacel QS and alkyldimethylammonium hydroxypropyl oxyethyl cellulose.

In one embodiment of the present invention, the cationic polymer comprises cationic starch. These are described by D. B. Solarek in Modified Starches, Properties and Uses published by CRC Press (1986) and in U.S. Pat. No. 7,135,451, col. 2, line 33—col. 4, line 67. In another embodiment, the cationic starch of the present invention comprises amylose at a level of from about 0% to about 70% by weight of the cationic starch. In yet another embodiment, when the cationic starch comprises cationic maize starch, the cationic starch comprises from about 25% to about 30% amylose, by weight of the cationic starch. In the above mentioned embodiments, other polymers comprising amylopectin can present in said cationic starch to fill the remainder percentages.

A third group of preferred polysaccahrides are cationic galactomanans, such as cationic guar gums or cationic locust bean gum. Examples of cationic guar gum are quaternary ammonium derivatives of hydroxypropyl guar sold under the trade names Jaguar C13 and Jaguar Excel available from Rhodia, Inc of Cranburry NJ and N-Hance by Aqualon, Wilmington, Del.

b. Synthetic Cationic Polymers

Synthetic cationic polymers in general and their method of manufacture are known in the literature. For example, a detailed description of cationic polymers can be found in an article by M. Fred Hoover that was published in the Journal of Macromolecular Science-Chemistry, A4(6), pp 1327-1417, October, 1970. The entire disclosure of the Hoover article is incorporated herein by reference. Other suitable cationic polymers are those used as retention aids in the manufacture of paper. They are described in “Pulp and Paper, Chemistry and Chemical Technology Volume III edited by James Casey (1981). The molecular weight of these polymers is in the range of about 80,000 to about 4,000,000 Da.

i. Addition Polymers

Synthetic polymers include but are not limited to synthetic addition polymers of the general structure

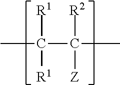

wherein R¹, R², and Z are defined herein below. Preferably, the linear polymer units are formed from linearly polymerizing monomers. Linearly polymerizing monomers are defined herein as monomers which under standard polymerizing conditions result in a linear or branched polymer chain or alternatively which linearly propagate polymerization. The linearly polymerizing monomers of the present invention have the formula:

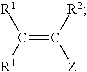

However, those of skill in the art recognize that many useful linear monomer units are introduced indirectly, inter alia, vinyl amine units, vinyl alcohol units, and not by way of linearly polymerizing monomers. For example, vinyl acetate monomers once incorporated into the backbone are hydrolyzed to form vinyl alcohol units. For the purposes of the present invention, linear polymer units may be directly introduced, i.e. via linearly polymerizing units, or indirectly, i.e. via a precursor as in the case of vinyl alcohol cited herein above.

Each R¹ is independently hydrogen, C1-C12 alkyl, substituted or unsubstituted phenyl, substituted or unsubstituted benzyl, —ORa, or —C(O)ORa wherein Ra is selected from hydrogen, and C1-C24 alkyl and mixtures thereof. Preferably R1 is hydrogen, C1-C4 alkyl, —ORa, or —(O)ORa.

Each R² is independently hydrogen, hydroxyl, halogen, C1-C12 alkyl, —ORa, substituted or unsubstituted phenyl, substituted or unsubstituted benzyl, carbocyclic, heterocyclic, and mixtures thereof. Preferred R² is hydrogen, C1-C4 alkyl, and mixtures thereof.

Each Z is independently hydrogen, halogen; linear or branched C1-C30 alkyl, nitrilo, N(R³)₂—C(O)N(R³)₂, —NHCHO (formamide); —OR³, —O(CH₂)ₙN(R³)₂, —O(CH₂)ₙN+(R³)_{3X}—, —C(O)OR4; —C(O)N—(R³)₂, —C(O)O(CH2)ₙN(R³)₂, —C(O)O(CH₂)ₙN+(R³)_{3X}, OCO(CH₂)ₙN(R³)₂, —OCO(CH₂)ₙN+(R³)_{3X}—, —C(O)NH(CH₂)ₙN(R³)₂, C(O)NH(CH₂)ₙN+(R³)_{3X}—, —(CH₂)ₙN(R³)₂, —(CH₂)ₙN+(R³)_{3X}—,

each R³ is independently hydrogen, C1-C24 alkyl, C2-C8 hydroxyalkyl, benzyl; substituted benzyl and mixtures thereof;

each R⁴ is independently hydrogen or C1-C24 alkyl, and

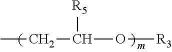

X is a water soluble anion; the index n is from 1 to 6.

R⁵ is independently hydrogen, C1-C6 alkyl,

and mixtures thereof.

Z can also be selected from non-aromatic nitrogen heterocycle comprising a quaternary ammonium ion, heterocycle comprising a N-oxide moiety, an aromatic nitrogen containing heterocyclic wherein one or more of the nitrogen atoms is quaternized; an aromatic nitrogen containing heterocycle wherein at least one nitrogen is a N-oxide; or mixtures thereof. Non-limiting examples of addition polymerizing monomers comprising a heterocyclic Z unit includes 1-vinyl-2-pyrrolidinone, 1-vinylimidazole, quaternized vinyl imidazole, 2-vinyl-1,3-dioxolane, 4-vinyl-1-cyclohexene-1,2-epoxide, and 2-vinylpyridine, 2-vinylpyridine N-oxide, 4-vinylpyridine 4-vinylpyridine N-oxide.

A non-limiting example of a Z unit which can be made to form a cationic charge in situ is the —NHCHO unit, formamide. The formulator can prepare a polymer or co-polymer comprising formamide units some of which are subsequently hydrolyzed to form vinyl amine equivalents.

The polymers and co-polymers of the present invention comprise Z units which have a cationic charge or which result in a unit which forms a cationic charge in situ. When the co-polymers of the present invention comprise more than one Z unit, for example, Z1, Z2, . . . Zn units, at least about 1% of the monomers which comprise the co-polymers will comprise a cationic unit.

The polymers or co-polymers of the present invention can comprise one or more cyclic polymer units which are derived from cyclically polymerizing monomers. Cyclically polymerizing monomers are defined herein as monomers which under standard polymerizing conditions result in a cyclic polymer residue as well as serving to linearly propagate polymerization. Preferred cyclically polymerizing monomers of the present invention have the formula:

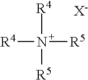

wherein each R⁴ is independently an olefin-comprising unit which is capable of propagating polymerization in addition to forming a cyclic residue with an adjacent R⁴ unit; R⁵ is C1-C12 linear or branched alkyl, benzyl, substituted benzyl, and mixtures thereof; X is a water soluble anion.

Non-limiting examples of R⁴ units include allyl and alkyl substituted allyl units. Preferably, the resulting cyclic residue is a six-member ring comprising a quaternary nitrogen atom.

R⁵ is preferably C1-C4 alkyl, preferably methyl.

An example of a cyclically polymerizing monomer is dimethyl diallyl ammonium having the formula:

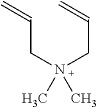

which results in a polymer or co-polymer having units with the formula:

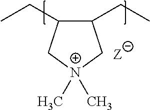

wherein preferably the index z is from about 10 to about 50,000.

Nonlimiting examples of preferred polymers according to the present invention include copolymers made from one or more cationic monomers selected from the group consisting

N,N-dialkylaminoalkyl methacrylate, N,N-dialkylaminoalkyl acrylate, N,N-dialkylaminoalkyl acrylamide, N,N-dialkylaminoalkylmethacrylamide, quaternized N,N-dialkylaminoalkyl methacrylate, quaternized N,N-dialkylaminoalkyl acrylate, quaternized N,N-dialkylaminoalkyl acrylamide, quaternized N,N-dialkylaminoalkylmethacrylamide vinylamine and its derivatives, allylamine and its derivatives, vinyl imidazole, quaternized vinyl imidazole and diallyl dialkyl ammonium chloride, and combinations thereof.

Optionally, a second monomer is selected from a group consisting of acrylamide, N,N-dialkyl acrylamide, methacrylamide, N,N-dialkylmethacrylamide, C1-C12 alkyl acrylate, C1-C12 hydroxyalkyl acrylate, polyalkylene glyol acrylate, C1-C12 alkyl methacrylate, C1-C12 hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole and derivatives, acrylic acid, methacrylic acid, maleic acid, vinyl sulfonic acid, styrene sulfonic acid, acrylamidopropylmethane sulfonic acid (AMPS) and their salts, and combinations thereof.

The polymer may optionally be crosslinked. Crosslinking monomers include, but are not limited to, ethylene glycoldiacrylatate, divinylbenzene and butadiene.

Preferred cationic monomers include N,N-dimethyl aminoethyl acrylate, N,N-dimethyl aminoethyl methacrylate (DMAM), [2-(methacryloylamino)ethyl]tri-methylammonium chloride (QDMAM), N,N-dimethylaminopropyl acrylamide (DMAPA), N,N-dimethylaminopropyl methacrylamide (DMAPMA), acrylamidopropyl trimethyl ammonium chloride, methacrylamidopropyl trimethylammonium chloride (MAPTAC), quaternized vinyl imidazole and diallyldimethylammonium chloride and derivatives thereof.

Preferred second monomers include acrylamide, N,N-dimethyl acrylamide, C1-C4 alkyl acrylate, C1-C4 hydroxyalkylacrylate, vinyl formamide, vinyl acetate, and vinyl alcohol. Most preferred nonionic monomers are acrylamide, hydroxyethyl acrylate (HEA), hydroxypropyl acrylate and derivative thereof,

The most preferred synthetic polymers are poly(acrylamide-co-diallyldimethylammonium chloride), poly(acrylamide-methacrylamidopropyltrimethyl ammonium chloride), poly(acrylamide-co-N,N-dimethyl aminoethyl methacrylate), poly(acrylamide-co-N,N-dimethyl aminoethyl methacrylate), poly(hydroxyethylacrylate-co-dimethyl aminoethyl methacrylate), poly(hydroxpropylacrylate-co-dimethyl aminoethyl methacrylate), poly(hydroxpropylacrylate-co-methacrylamidopropyltrimethylammonium chloride), poly(acrylamide-co-diallyldimethylammonium chloride-co-acrylic acid), poly(acrylamide-methacrylamidopropyltrimethyl ammonium chloride-co-acrylic acid).

ii. Polyethyleneimine and its Derivatives.

These are commercially available under the trade name of Lupasol from BASF AG of Ludwigschaefen, Germany. In one embodiment, the polyethylene derivative is an amide derivative of polyetheyleneimine sold under the trade name Lupoasol SK. Also included are alkoxylated polyethleneimine; alkyl polyethyleneimine and quaternized polyethyleneimine.

iii. Polyamidoamine-Epichlorohydrin (PAE) Resins

PAE resin is a condensation product of polyalkylenepolyamine with polycarboxylc acid. The most common PAE resins are the condensation products of diethylenetriamine with adipic acid followed by a subsequent reaction with epichlorohydrin. They are available from Hercules Inc. of Wilmington Del. under the trade name Kymene or from BASF A.G. under the trade name Luresin. These polymers are described in Wet Strength Resins And Their Applications edited by L. L. Chan, TAPPI Press (1994).

e) Surfactant

The surfactant can be selected from non-ionic, cationic, anionic, zwitterionic surfactants and mixtures thereof. The surfactant may be a non-ionic surfactant, an anionic surfactant or a mixture thereof. The surfactant may be a non-ionic surfactant, or even an alkoxylated non-ionic surfactant.

The nonionic surfactant can for example be an alkoxylated non-ionic surfactant such as a condensate of ethylene oxide with a long chain (fatty) alcohol or (fatty) acid, for example C₁₄₋₁₅ alcohol, condensed with 7 moles of ethylene oxide, a condensate of ethylene oxide with an amine or an amide, or a condensation product of ethylene and propylene oxides. Further suitable nonionic surfactants include siloxane polyoxyalkylene copolymers, fatty acid alkylol amides, fatty amine oxides, esters of sucrose, glycerol or sorbitol and fluoro-surfactants.

Suitable non-ionic surfactants include alkyl polyglucoside and/or an alkyl alkoxylated alcohol. Preferred non-ionic alkyl alkoxylated alcohols include C₈₋₁₈ alkyl alkoxylated alcohol, preferably a C₈₋₁₈ alkyl ethoxylated alcohol, preferably the alkyl alkoxylated alcohol has an average degree of alkoxylation of from 1 to 50, preferably from 1 to 30, or from 1 to 20, or from 1 to 10, preferably the alkyl alkoxylated alcohol is a C₈₋₁₈ alkyl ethoxylated alcohol having an average degree of ethoxylation of from 1 to 10, preferably from 1 to 7, more preferably from 1 to 5 and most preferably from 3 to 7. The alkyl alkoxylated alcohol can be linear or branched, and substituted or un-substituted. Suitable non-ionic surfactants can be selected from the group consisting of: C₈-C₁₈ alkyl ethoxylates, such as, NEODOL® non-ionic surfactants from Shell; C₆-C₁₂ alkyl phenol alkoxylates wherein preferably the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols; C₁₄-C₂₂ mid-chain branched alkyl alkoxylates, preferably having an average degree of alkoxylation of from 1 to 30; alkylpolysaccharides, preferably alkylpolyglycosides; polyhydroxy fatty acid amides; ether capped poly(oxyalkylated) alcohol surfactants; and mixtures thereof.

Anionic surfactants can include sulphate and sulphonate surfactants. Preferred sulphonate surfactants include alkyl benzene sulphonate, preferably C₁₀₋₁₃ alkyl benzene sulphonate. Suitable alkyl benzene sulphonate (LAS) is obtainable, preferably obtained, by sulphonating commercially available linear alkyl benzene (LAB); suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic surfactant is alkyl benzene sulphonate that is obtained by DETAL catalyzed process, although other synthesis routes, such as HF, may also be suitable. Preferred sulphate surfactants include alkyl sulphate, preferably C₈₋₁₈ alkyl sulphate, or predominantly C₁₂ alkyl sulphate. Another preferred sulphate surfactant is alkyl alkoxylated sulphate, preferably alkyl ethoxylated sulphate, preferably a C₈₋₁₈ alkyl alkoxylated sulphate, preferably a C₈₋₁₈ alkyl ethoxylated sulphate, preferably the alkyl alkoxylated sulphate has an average degree of alkoxylation of from 0.5 to 20, preferably from 0.5 to 10, preferably the alkyl alkoxylated sulphate is a C₈₋₁₈ alkyl ethoxylated sulphate having an average degree of ethoxylation of from 0.5 to 10, preferably from 0.5 to 7, more preferably from 0.5 to 5 and most preferably from 0.5 to 3. The alkyl sulphate, alkyl alkoxylated sulphate and alkyl benzene sulphonates may be linear or branched, substituted or un-substituted.

Suitable organic anionic surfactants include alkyl aryl sulphonates, for example sodium dodecyl benzene sulphonate, long chain (fatty) alcohol sulphates, olefin sulphates and sulphonates, sulphated monoglycerides, sulphated esters, sulphonated or sulphated ethoxylate alcohols, sulphosuccinates, alkane sulphonates, alkali metal soaps of higher fatty acids, phosphate esters, alkyl isethionates, alkyl taurates and/or alkyl sarcosinates.

Suitable cationic surfactants include alkyl pyridinium compounds, alkyl quaternary ammonium compounds, alkyl quaternary phosphonium compounds, alkyl ternary sulphonium compounds, and mixtures thereof. Preferred cationic surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, preferred anions include: halides, preferably chloride; sulphate; and sulphonate. Preferred cationic detersive surfactants are mono-C₆₋₁₈ alkyl mono-hydroxyethyl di-methyl quaternary ammonium chlorides. Highly preferred cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

A cationic surfactant can for example be an alkylamine salt, a quaternary ammonium salt, a sulphonium salt or a phosphonium salt.

A zwitterionic (amphoteric) surfactant can for example be an imidazoline compound, an alkylaminoacid salt or a betaine.

Without being bound by theory, the surfactant (e) enhances the effect of the cationic polymer (d) in suppression of foam in the rinse compared to suppression of foam during the wash. The weight ratio of the cationic polymer (d) to the surfactant (e) is preferably between 1:9 and 9:1. The cationic polymer (d) and the surfactant (e) can conveniently be mixed together before being mixed with the other components of the foam control granule, although they can be added separately if desired.

### Additional Detergent Ingredients

The balance of the laundry detergent typically contains from about 5% to about 70%, or about 10% to about 60% adjunct ingredients. Suitable detergent ingredients include: transition metal catalysts; imine bleach boosters; enzymes such as amylases, carbohydrases, cellulases, laccases, lipases, bleaching enzymes such as oxidases and peroxidases, proteases, pectate lyases and mannanases; source of peroxygen such as percarbonate salts and/or perborate salts, preferred is sodium percarbonate, the source of peroxygen is preferably at least partially coated, preferably completely coated, by a coating ingredient such as a carbonate salt, a sulphate salt, a silicate salt, borosilicate, or mixtures, including mixed salts, thereof; bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide; suds suppressing systems such as silicone based suds suppressors; brighteners; hueing agents; photobleach; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as oligomers produced by the condensation of imidazole and epichlorhydrin; soil dispersants and soil anti-redeposition aids such as alkoxylated polyamines and ethoxylated ethyleneimine polymers; anti-redeposition components such as polyesters and/or terephthalate polymers, polyethylene glycol including polyethylene glycol substituted with vinyl alcohol and/or vinyl acetate pendant groups; perfumes such as perfume microcapsules, polymer assisted perfume delivery systems including Schiff base perfume/polymer complexes, starch encapsulated perfume accords; soap rings; aesthetic particles including coloured noodles and/or needles; dyes; fillers such as sodium sulphate, although it may be preferred for the composition to be substantially free of fillers; carbonate salt including sodium carbonate and/or sodium bicarbonate; silicate salt such as sodium silicate, including 1.6R and 2.0R sodium silicate, or sodium metasilicate; co-polyesters of di-carboxylic acids and diols; cellulosic polymers such as methyl cellulose, carboxymethyl cellulose, hydroxyethoxycellulose, or other alkyl or alkylalkoxy cellulose, and hydrophobically modified cellulose; carboxylic acid and/or salts thereof, including citric acid and/or sodium citrate; and any combination thereof.

Other surfactants useful herein include cationic surfactants, nonionic surfactants, and amphoteric surfactants. Such surfactants are well known for use in laundry detergents and are typically present at levels of from about 0.2% or 1% to about 40% or 50%.

### Process for Washing Fabrics

The present invention is also to a method of cleaning fabric, said method comprising the steps of:
a) providing a laundry detergent according to the present invention;
b) forming a laundry liquor by diluting the laundry detergent, wherein the anionic surfactant level of the laundry liquor is at least 80 ppm;
c) washing the fabric in the laundry liquor;
d) rinsing the fabric in water, wherein the anionic surfactant detersive concentration is no more than 25 wt % of the anionic detersive surfactant concentration in step b).

The anionic detersive surfactant concentration in the laundry liquor during washing is preferably at least about 80 ppm, or 140 ppm, or 200 ppm, or 400 ppm, or 600 ppm, and the concentration of anionic detersive surfactant during rinsing is no more than 25 wt % of the anionic detersive surfactant concentration during the wash step, for example it is no more than 200 ppm, or 150 ppm, or 100 ppm, or 80 ppm, or 50 ppm.

### Process for Making

The present laundry detergents may be prepared by mixing the granulated foam control composition with the anionic surfactant. The anionic surfactant is typically in a form of a water-soluble granule formed by agglomeration and/or spray drying and/or extrusion, and manufacturing processes thereof may be either batch or continuous process, both of which are well known in the art.

One aspect of the present invention is a method of manufacturing a granulated foam control composition comprising:

Preparing a foam control particle, comprising mixing
(a) a foam control agent comprising
(i) a polydiorganosiloxane fluid comprising units of the formula

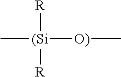

where each group R, which may be the same or different, is selected from an alkyl group having 1 to 36 carbon atoms or an aryl group or aralkyl group having up to 36 carbon atoms, the mean number of carbon atoms in the groups R being at least 1.3;
(ii) a hydrophobic filler dispersed in the polydiorganosiloxane fluid; and
(iii) optionally an organosilicon resin; and
(b) an organic additive of melting point 45 to 100° C. comprising a polyol ester which is a polyol fully or partially esterified by carboxylate groups each having 7 to 36 carbon atoms; and
depositing the mixture of (a) and (b) on a water-soluble particulate inorganic carrier, the mixture of (a) and (b) being in non-aqueous liquid form prior to depositing it on the water-soluble particulate inorganic carrier; and
depositing a mixture of (d) a polymer having a net cationic charge and a surfactant (e) on the water-soluble particulate inorganic carrier,
wherein the mixture of (a) and b) and the mixture of (d) and (e) are deposited onto the water-soluble inorganic carrier either simultaneously or sequentially.

In a subsequent step, the granulated foam control composition can be added to laundry detergent composition.

In one aspect, the surfactant (e) may be added independently or as a mixture together with the polymer having a net cationic charge.

In one embodiment, the mixture of cationic polymer (d) and surfactant (e) is mixed with the foam control agent (a) and the organic additive (b) prior to being deposited on the particulate carrier. The mixture of (d) and (e) may first be prepared followed by the addition of the mixture of (a) and (b) into (d) and (e).

In one embodiment a co-acervate of anionic surfactant and cationic polymer is prepared before addition to foam control agent and organic additive. The co-acervate may further comprise non-ionic surfactant.

The mixture of foam control agent and organic additive is preferably deposited on the particulate carriers at a temperature at which the organic additive is liquid, for example a temperature in the range of about 45-100° C. As the mixture cools on the particulate carriers, it solidifies to a structure which contributes to the increased efficiency of the foam control composition. The foam control composition is preferably made by an agglomeration process in which the foam control composition comprising the foam control agent and the organic additive is sprayed onto the particulate carriers while agitating the particles. In one embodiment, the particles are agitated in a high shear mixer through which the particles pass continuously. The mixture of (d) and e) and the mixture of a) and (b) can be deposited onto the water-soluble particulate inorganic carrier via a spray nozzle. In one aspect, the mixture of (d) and (e) and the mixture of (a) and (b) are mixed together in the tip of the nozzle just prior to being sprayed.

One type of suitable mixer is a vertical, continuous high shear mixer in which the foam control composition is sprayed onto the particles. One example of such a mixer is available under the name Flexomix mixer from Hosokawa Schugi.

Alternative suitable mixers which may be used include horizontal high shear mixers, in which an annular layer of the powder-liquid mixture is formed in the mixing chamber, with a residence time of a few seconds up to about 2 minutes. Examples of this family of machines are pin mixers, e.g., TAG series from LB, RM-type machines from Rubberg-Mischtechnik or other pin mixers supplied by Lodige, and paddle mixers, e.g. CB series from Lodige, Corimix from Drais-Manheim and Conax from Ruberg Mischtechnik.

Other possible mixers which can be used in the process of the invention are Glatt granulators, ploughshare mixers, as sold for example by Lodige GmbH, twin counter-rotating paddle mixers commercially available under the name Forberg, intensive mixers including a high shear mixing arm within a rotating cylindrical vessel, commercially available under the name Typ R from Eirich, under the name Zig-Zag from Patterson-Kelley, and under the name HEC from Niro.

### Wash Suds Index and Rinse Suds Index

Wash Suds Index is used to compare the suds volume generated during the washing stage by the present laundry detergent comprising a granulated foam control composition versus a laundry detergent alone without the present granulated foam control composition as a control. Herein, the suds volume is measured by the suds height following a standardized washing process described below.

Rinse Suds Index is used to compare the suds volume remaining after rinsing of the present laundry detergents comprising granulated foam control composition versus the laundry detergents alone as a control. Herein the suds volume is measured by the surface area of suds in a rinsing basin following a standardized rinsing process described below.

The present laundry detergent used to conduct the experiments includes by weight of the laundry detergent, 0.5% of present and comparative granulated foam control composition, 11% of linear alkyl benzene sulphonate, 1% of alkyl dimethyl hydroxyl ethyl ammonium chloride, 3.5% of C14-15 alkyl ethoxylated alcohol having a molar average degree of ethoxylation of 9, 20% sodium alumino silicate (Zeolite), 15% sodium carbonate, 28% sodium sulphate, 2% sodium silicate, 1.5% carboxy methyl cellulose, 4% of poly acrylic acid, 2% sodium percarbonate, 0.5% of tetraacetylethylenediamine (TAED), and includes enzymes et.al which make the total amount of all the components add up to 100%.

Standard Washing Process:
1) Fill a basin with 2 L DI water (4 gpg) and dissolve the laundry detergents to reach a concentration of 3500 ppm in the water and swirl for 2 min until it fully dissolves and forms a laundry liquor.
2) Put a piece of fabric into the laundry liquor and soak for 5 min.
3) For each piece of fabric, scrub it 5 times, dip back into the laundry liquor between each scrub.
4) Wring the scrubbed fabric gently, not disturbing the suds produced.
5) Measure the total height of the suds and laundry liquor, by taking a average from five measures including one center point and four edge points of the basin;
6) Measure the laundry liquor height in the basin by removing suds from the basin;
7) Get suds height by deducting the measurement in step 6) from step 5).

Standard Rinsing Process:
1) Put the washed and wringed piece of fabric into a new basin comprising 2 L of fresh DI water (4 gpg) by control the laundry liquor carryover to be 200±5 g (carryover=total weight after wash−dry fabric weight). Rinse each piece of fabric through 3 gentle scrubs.
2) Take a picture for the suds coverage on the rinse water surface on 5-10 sec after removing the piece of fabric from the water.

As a summary, the conditions set for the washing and rinsing process are provided in below table.

| | | | |
|---|---|---|---|
| Product concentration | 3500 ppm | Soaking time: | 5 min |
| Water volume: | 2 L | Washing scrubs: | 5 scrubs |
| Water hardness | 4 gpg, Ca:Mg = 4:1 | 1^{st}/2^{nd} rinse time: | 3 scrubs |
| Water temperature | 20-25° C. | Rinse method: | Hand |
| | | | wash |

| | |
|---|---|
| Grading method: | Ruler to measure suds height when coverage |
| | area = 100% or picture for coverage percentage |
| | when coverage <100% |
| Fabric: | 1 piece of terry towel (20 cm × 20 cm), 2 pieces |
| | of knitted cotton (40 cm × 40 cm). Total dry |
| | weight = 115 ± 3 g |

### EXAMPLES

Laundry detergents according to the present invention were tested versus laundry detergents outside of the scope of the present invention for rinse suds removal and also storage stability.

Granulated foam control compositions according to the present invention were made as follows;

Six percent (6%) by weight treated precipitated silica available under the name Sipernat D10 from Evonik and 1% partially hydrophobic silica available under the name R972 from Evonik are dispersed in 86.3% polydiorganosiloxane fluid having a degree of polymerisation of 65 and comprising 80 mole % methyl ethyl siloxane groups, 19 mole % methyl 2-phenylpropyl (derived from α-methylstyrene) siloxane groups and 1 mole % divinyl crosslinking groups. 6.7% by weight of a 60% by weight solution of an organosiloxane resin having trimethyl siloxane units and SiO2 units in a M/Q ratio of 0.65/1 in octyl stearate (70% solid) is added. The mixture is homogenized through a high shear mixer to form a foam control agent FC 1.

First pass: 62.00 parts by weight of the foam control agent FC1 was mechanically mixed with 38.00 parts of glyceryl tristearate provided by Sasol. The FC1 and molten glyceryl tristearate were mixed at 90° C. The glyceryl tristearate and polydiorganosiloxane fluid were miscible and the mixture had a melting point of 74° C. 18.25 parts of the mixture of glyceryl tristearate and FC1, and 4.20 parts water were sprayed at the same time on two separate nozzles onto 77.55 parts of sodium sulfate powder in a Schugi Flexo mixer to generate a granular particulate material. The water contained in this granulated foam control composition was removed in a fluidized bed.

Second pass: 47.15 parts of polyacrylamide methacrylamidopropyl trimethylammonium chloride (PAM MAPTAC) cationic polymer, 5.70 parts of C14-15 AE7 nonionic surfactant, and 47.15 parts of water were mechanically mixed. The obtained granular particulate material from the first pass was put back into the Schugi Flexo mixer at 97.32 parts, where 2.68 parts of the aqueous solution of PAM MAPTAC/nonionic surfactant solution were sprayed onto it. The water contained in this granulated foam control composition was removed in a fluidized bed. The resultant granulated foam control composition was labeled Granule 1.

A granulated foam control composition outside of the present invention was made using the process as described above, however, no C14-15 AE7 nonionic surfactant was added in the second pass. Instead, 50 parts of PAM MAPTAC cationic polymer, and 50 parts of water were mechanically mixed. The obtained granular particulate material from the first pass was put back into the Schugi Flexo mixer at 97.32 parts, where 2.68 parts of the aqueous solution of PAM MAPTAC were added. The resultant granulated foam control composition was labeled Granule 2. An overview of the granule compositions can be seen in Table 1

TABLE 1

| | Foam | | Inorganic | | |
|---|---|---|---|---|---|
| | control | Organic | particulate | Cationic | |
| Wt % | agent | additive | carrier | polymer | surfactant |
| Granule 1 | 11.78 | 7.22 | 80.76 | 0.08 | 0.16 |
| Granule 2 | 11.80 | 7.23 | 80.88 | 0.09 | 0 |

Granule 1 and granule 2 (0.5 wt %) were independently added to existing ‘off the shelf’ granular laundry detergent compositions comprising anionic detersive surfactant. For the purpose of this test, Ariel brand granular laundry detergent available in China was used. A control of just Ariel laundry detergent was also included.

The compositions were then tested for wash suds index and rinse suds index following the test method described herein. Results can be seen in Table 2.

TABLE 2

| | Wash Suds | Rinse Suds |
|---|---|---|
| Test Leg | Index | Index |
| Control-China Ariel | 100% | 100% |
| China Ariel + Granule 1 | 99% | 15% |
| China Ariel + Granule 2 | 89% | 25% |

As can be seen from Table 2, laundry detergents according to the present invention exhibit a wash suds index that is comparable to the control comprising no foam reduction agent, but also exhibit the lowest rinse suds index.

It was also surprisingly found that laundry detergent compositions according to the present invention also exhibited improved ageing stability.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

What is claimed is:

1. A laundry detergent comprising a granulated foam control composition and an anionic detersive surfactant, wherein said granulated foam control composition comprises:
(a) a foam control agent comprising:
i. a polydiorganosiloxane fluid comprising units of the formula 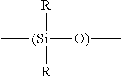
where each group R, which may be the same or different, is selected from an alkyl group having 1 to 36 carbon atoms or an aryl group or aralkyl group having 1 to 36 carbon atoms, the mean number of carbon atoms in the groups R being at least 1.3;
ii. a hydrophobic filler dispersed in the polydiorganosiloxane fluid;
(b) an organic additive having a melting point of from about 45° C. to about 100° C. comprising a polyol ester which is a polyol esterified by carboxylate groups each having 7 to 36 carbon atoms, and which is miscible with said polydiorganosiloxane fluid;
(c) a water soluble inorganic particulate carrier;
(d) a cationic polymer;
(e) a surfactant.

2. The laundry detergent according to claim 1, wherein the granulated foam control composition comprises a foam control particle comprising a core comprising the polydiorganosiloxane fluid, the hydrophobic filler and the water soluble inorganic particulate carrier, and the core is at least partially coated with a coating comprising the cationic polymer and the surfactant.

3. The laundry detergent according to claim 1, wherein the ratio of the cationic polymer to the surfactant in the granulated foam control composition is between 1:9 and 9:1.

4. The laundry detergent according to claim 1, wherein the surfactant in granulated foam control composition is selected from the group comprising, non-ionic, cationic, anionic and zwitterionic surfactants, preferably the surfactant is a non-ionic surfactant, more preferably an alkoxylated non-ionic surfactant.

5. The laundry detergent according to claim 1, wherein said polydiorganosiloxane fluid in the granulated foam control composition is a polysiloxane comprising either;
a) at least 10% diorganosiloxane units of the formula 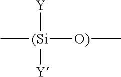
and up to 90% diorganosiloxane units of the formula 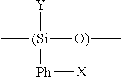
wherein X denotes a divalent aliphatic organic group bonded to silicon through a carbon atom; Ph denotes an aromatic group; Y denotes an alkyl group having 1 to 4 carbon atoms; and Y′ denotes an aliphatic hydrocarbon group having 1 to 24 carbon atoms; or
b) 50-100% diorganosiloxane units of the formula 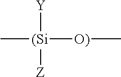
wherein Y denotes an alkyl group having 1 to 4 carbon atoms and Z denotes an alkyl group having 6 to 18 carbon atoms; and
optionally up to 50% diorganosiloxane units of the formula 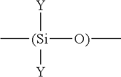
wherein Y denotes an alkyl group having 1 to 4 carbon atoms and Z denotes an alkyl group having 6 to 18 carbon atoms; or
c) a mixture thereof.

6. The laundry detergent according to claim 1, wherein the water soluble inorganic particulate carrier in the granulated foam control composition is selected from the group consisting of sodium chloride, sodium sulfate, sodium carbonate, sodium bicarbonate, and combinations thereof.

7. The laundry detergent according to claim 1, wherein the cationic polymer can be;
a) a cationic polysaccharide; or
b) a synthetic addition polymer of the general structure 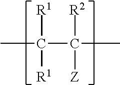
wherein each R¹ is independently hydrogen, C₁-C₁₂ alkyl, substituted or unsubstituted phenyl, substituted or unsubstituted benzyl, —ORₐ, or —C(O)ORₐ wherein Rₐ is selected from hydrogen and C₁-C₂₄ alkyl and mixtures thereof; each R² is independently hydrogen, hydroxyl, halogen, C₁-C₁₂ alkyl, —ORₐ, substituted or unsubstituted phenyl, substituted or unsubstituted benzyl, carbocyclic or heterocyclic; and each Z is independently hydrogen, halogen; linear or branched C₁-C₃₀ alkyl, nitrilo, N(R₃)₂—C(O)N(R₃)₂; —NHCHO (formamide); —OR³, —O(CH₂)ₙN(R³)₂, —O(CH₂)ₙN⁺(R³)₃X⁻, —C(O)OR⁴; —C(O)N—(R³)₂, —C(O)O(CH₂)ₙN(R³)₂, —C(O)O(CH₂)ₙN⁺(R³)₃X⁻, —OCO(CH₂)ₙN(R³)₂, —OCO(CH₂)ₙN⁺(R³)₃X⁻, —C(O)NH—(CH₂)ₙN(R³)₂, —C(O)NH(CH₂)ₙN⁺(R³)₃X⁻, —(CH₂)ₙN(R³)₂, —(CH₂)ₙN⁺(R³)₃X⁻, or a non-aromatic nitrogen heterocycle comprising a quaternary ammonium ion, heterocycle comprising an N-oxide moiety, an aromatic nitrogen containing heterocyclic wherein one or more or the nitrogen atoms is quaternized; an aromatic nitrogen containing heterocycle wherein at least one nitrogen is an N-oxide; each R₃ being independently hydrogen, C₁-C₂₄ alkyl, C₂-C₈ hydroxyalkyl, benzyl or substituted benzyl; each R₄ being independently hydrogen or C₁-C₂₄ alkyl or —(CH₂—CHR₅—O)ₘ—R³, where R₅ is independently hydrogen or C₁-C₆ alkyl; X being a water soluble anion; and n being from 1 to 6; provided that at least one Z group per molecule is selected from —O(CH₂)ₙN⁺(R³)₃X⁻, —C(O)OR⁴; —C(O)N—(R³)₂, —C(O)O(CH₂)ₙN(R³)₂, —C(O)O(CH₂)ₙN⁺(R³)₃X⁻, —OCO(CH₂)ₙN(R³)₂, —OCO(CH₂)ₙN⁺(R³)₃X⁻, —C(O)NH—(CH₂)ₙN(R³)₂, —C(O)NH(CH₂)ₙN⁺(R³)₃X⁻, —(CH₂)ₙN(R³)₂, —(CH₂)ₙN⁺(R³)₃X⁻, or a non-aromatic nitrogen heterocycle comprising a quaternary ammonium ion, heterocycle comprising a N-oxide moiety, an aromatic nitrogen-containing heterocyclic wherein one or more or the nitrogen atoms is quaternized; an aromatic nitrogen-containing heterocycle wherein at least one nitrogen is an N-oxide; or
c) a mixture thereof.

8. The laundry detergent according to claim 1, wherein the granulated foam control composition comprises a water-insoluble inorganic ingredient, preferably the water-insoluble inorganic ingredient being zeolite or silica, most preferably zeolite.

9. The laundry detergent according to claim 1, wherein the foam control particle has a mean particle size of between 150 and 700 μm, preferably between 150 and 500 μm, most preferably between 200 and 500 μm.

10. The laundry detergent according to claim 1 wherein the foam control particle comprises between 5 and 15%, preferably between 7 and 12% by weight of the foam control particle of polydiorganosiloxane fluid.

11. A method of cleaning fabric, said method comprising the steps of:
a. providing a laundry detergent according to any of claims 1-10;
b. forming a laundry liquor by diluting the laundry detergent, wherein the anionic surfactant level of the laundry liquor is at least 80 ppm;
c. washing the fabric in the laundry liquor;
d. rinsing the fabric in water, wherein the anionic surfactant level is no more than ¼ of the level in step b).

12. A method of conserving water when washing fabric, said method comprising the step of washing a fabric according to the method of claim 14, wherein step d) is performed one time.

13. A method of manufacturing a laundry detergent comprising mixing a granulated foam control composition with an anionic surfactant, wherein the granulated foam control composition is manufactured by mixing;
(a) a foam control agent comprising
(i) a polydiorganosiloxane fluid comprising units of the formula 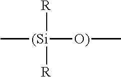
where each group R, which may be the same or different, is selected from an alkyl group having 1 to 36 carbon atoms or an aryl group or aralkyl group having up to 36 carbon atoms, the mean number of carbon atoms in the groups R being at least 1.3;
(ii) a hydrophobic filler dispersed in the polydiorganosiloxane fluid; and
(iii) optionally an organosilicon resin; and
(b) an organic additive of melting point 45 to 100° C. comprising a polyol ester which is a polyol fully or partially esterified by carboxylate groups each having 7 to 36 carbon atoms; and
depositing the mixture of (a) and (b) on a water-soluble particulate inorganic carrier, the mixture of (a) and (b) being in non-aqueous liquid form prior to depositing it on the water-soluble particulate inorganic carrier; and
depositing a mixture of (d) a cationic polymer and a surfactant (e) on the water-soluble particulate inorganic carrier,
wherein the mixture of (a) and (b) and the mixture of (d) and (e) are deposited onto the water-soluble inorganic carrier either simultaneously or sequentially.

14. The method according to claim 13, wherein the mixture of cationic polymer (d) and surfactant (e) is mixed with the foam control agent (a) and the organic additive (b) prior to being deposited on the particulate carrier, preferably where the mixture of (d) and (e) is first prepared followed by the addition of the mixture of (a) and (b) into (d) and (e).

15. The method according to claim 14, wherein the mixture of (d) and (e) and the mixture of (a) and (b) are deposited onto the water-soluble particulate inorganic carrier via a spray nozzle and wherein the mixture of (d) and (e) and the mixture of (a) and (b) are mixed together in the tip of the nozzle just prior to being sprayed.
